(19) United States
(12) Patent Application Publication
(10) Pub. No.: US 2006/0061451 A1
(43) Pub. Date: Mar. 23, 2006

(54) Personalized control device having security mechanism

(76) Inventor: Shoei-Lai Chen, Taipei (TW)

Correspondence Address: Yi-Wen Tseng, 4331 Stevens Battle Lane, Fairfax, VA, 22033, US

(21) Appl. No.: 10/942,964

(22) Filed: Sep. 17, 2004

(51) Int. Cl. H04Q 1/00; G05B 19/00

(52) U.S. Cl. 340/5.53; 340/5.74; 348/156

(57) ABSTRACT

A personalized control device having a security mechanism, which sets up identification condition and operation condition such as activation, allowable channel, time and program and accessible network for certain identification condition, such that only the user having the identification characteristics matching the identification condition can activated the device. In addition, once the device is activated, the operation mode of the device is still limited according to the identification characteristics of the user.

### BACKGROUND OF THE INVENTION

The present invention relates in general to a personalized control device having a security mechanism, and more particularly, to a personalized device that combines identification unit with remote control or activation device having a security mechanism that allows a device under controlled to be used only for uses with certain identities or at certain ages.

The development and exploration of information technologies have come to a stage that information is so easy to obtain through various types of media. For example, the continuous increase of television channels provides all types of programs, and the computer and network instantaneously connects websites all over the world.

However, the fast development of information technologies and the convenience of information retrieval consequently cause problems such as the easy access of violence, blood, and pornographic information. Such content does not only influence adults, but also causes great impact of adolescent or even young children. What is worse is that such type of content is often the most popular information to be accessed in various media. It is thus a substantial need to provide security code or identification process to limit the user for accessing such content.

### BRIEF SUMMARY OF THE INVENTION

A personalized control device having a security mechanism is provided, which sets up identification condition and operation condition such as activation, allowable channel, time and program and accessible network for certain identification condition, such that only the user having the identification characteristics matching the identification condition can activated the device. In addition, once the device is activated, the operation mode of the device is still limited according to the identification characteristics of the user.

Accordingly, the personalized device having a security mechanism provided by the present invention includes a control unit, a setup unit and an identification unit. The control unit has an input unit. The setup unit is for inputting identification characteristics of a user and operation limitation for the user according to the identification characteristics thereof. The identification unit is for identifying the user.

### BRIEF DESCRIPTION OF THE DRAWINGS

The above objects and advantages of the present invention will be become more apparent by describing in detail exemplary embodiments thereof with reference to the attached drawings in which:

FIG. 1 is a block diagram of the personalized control device;

FIG. 2 shows the structure of the personalized control device;

FIG. 3 shows the operation process of the personalized control device in a setup mode; and

FIG. 4 shows the operation process of the personalized control device in an identification mode.

### DETAILED DESCRIPTION OF THE INVENTION

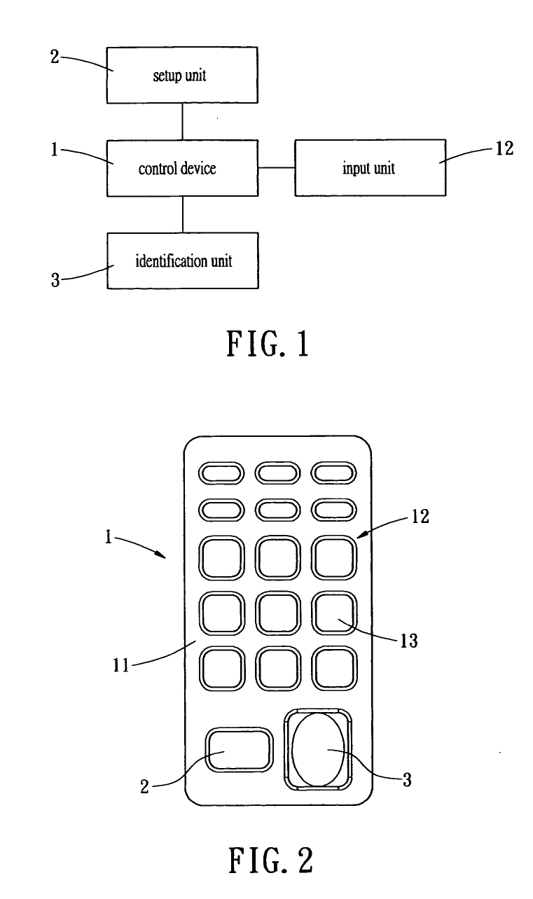

Referring to FIG. 1, a personalized control device having security mechanism is illustrated. As shown, the device includes a control unit 1, a setup unit 2 allowing the user to set up the usage condition and range, and an identification unit 3 for identifying the user and operating conditions.

The control device 1 provides the means for giving instructions or commands to the device to be controlled, including various home appliances such as television, computers, or other communication devices. The control device 1 includes a control box 11 that has the setup unit 2, a timing unit and a circuit mechanism such as a control circuit having universal code (not shown). The control box 11 includes an input unit 12 on a surface thereof. In this embodiment, the input unit 12 includes a plurality of control keys 13 allowing user to input identification conditions and to order operation instructions. The control unit 1 can be implemented by a remote control or a power activation control device that controls the on and off state of a power source.

In one embodiment, the identification unit 3 may be installed on the surface of the control unit 1. The identification unit 3 is used to identify the characteristics of the user, including the fingerprint, voiceprint and retina.

The setup unit 2 allows the user to use the input unit 12 of the control unit 1 to perform the input of using condition and user identification. The setup unit 12 can also be used in combination with the identification unit 3, such that activation of the device to be used, the channel to be selected, the application time of the device, or the program that can be watched can be limited as desired. The setup condition can also be stored in the memory unit of the control unit 1.

The identification unit 3 is used to compare the input condition with the setup condition, so as to identify the user. Only when the identification of the user matches with the condition previously set up by the setup unit 2, the device can be activated, and the user can operate the device.

In many applications, the identification unit 3 is not limited to identify characteristics of the user such as finger print. Other characteristics such as voiceprint, or even password can also be input as an identification condition for determining whether the device can be activated or not.

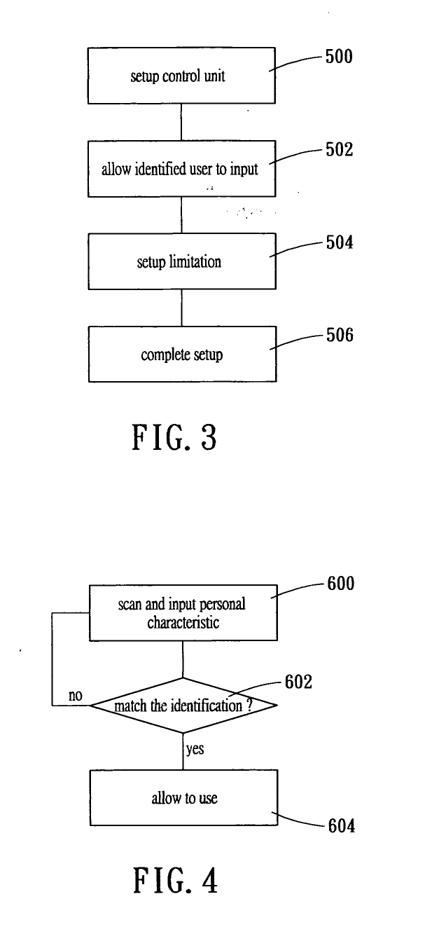

The control unit 1, the setup unit 2 and the identification unit 3 thus construct a personalized control device that has a security mechanism to limit the access of a device, particularly an information device such as television or computer network. The operation process of the personalized control device is illustrated in FIGS. 3 and 4, which can be divided into a setup control mode and an operation control mode.

In the setup control mode, the setup unit 2 is used to set up the using limitation and the identification for the user. As shown in FIG. 3, the setup function of the control unit 1 is called up in step 500. The identification of the allowed user is then input via the setup unit 2 in step 502. When the password is used for identification, the selected password is input via the control keys 13 of the input unit 12. The input password is then stored in the memory of the control device. When the fingerprint, voiceprint or retina of the user is input and used for identification, the fingerprint, voiceprint or retina is scanned or recorded in the memory.

When the identification condition is input in the control device, the using limitation of the device is set up in step 504. For example, the operation function, including the activation, the accessible channel, application time, program allowed to be watched, and the accessible network is set up in this step. The using limitation is also stored in the memory, such that the setup process for both identification and using limitation is complete in step 506.

When a user intends to use the device 1, as shown in FIG. 4, the identification of the user has to be input first. When the password is used for identification, the user must input the password as previously set up via the control keys 13. When the identification requires personal characteristic such as fingerprint, voiceprint or retina, the personal characteristic is scanned and input to the device in step 600. The input identification information is then compared to the identification information stored in the memory in step 602. When the input identification information matches that stored in the memory, the device can be activated in step 604, otherwise, the request is denied, or re-entry of identification information is required.

The using limitation allows the user in different condition such as different ages to control the device under different modes. For example, the children under a certain age is allowed to activate the device, but is only allowed to access certain channel or website.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A personalized device having a security mechanism, comprising:
a control unit having an input unit;
a setup unit for inputting identification characteristics of a user and operation limitation for the user according to the identification characteristics thereof; and
an identification unit for identifying the user.

2. The device of claim 1, wherein the setup unit allows the user to input and save the identity thereof.

3. The device of claim 1, wherein the identification characteristics includes fingerprint, voiceprint or retina.

4. The device of claim 1, wherein the operation limitation includes an activation status, allowable channel, allowable operation time, allowable program and allowable network.

5. The device of claim 1, wherein the identification unit includes a identification device for identify fingerprint, voiceprint or retina.

6. The device of claim 1, wherein the control unit includes a remote control or a power activation control.

7. The device of claim 1, wherein the control unit comprises a control box in which the setup unit, a timer and a control circuit having a universal code are installed, and an input unit having plurality of control keys is formed on a surface of the control box.

8. A personalized control device having a security mechanism, comprising:
a control unit;
an input unit installed at the control unit allowing a user to provide identification information thereof; and
a setup unit mounted to the control unit allowing the user to set up identification condition and operation condition;

9. The device of claim 8, wherein the setup unit allows the user to input the identification condition via the input unit.

10. The device of claim 8, wherein the identification condition includes a password.

11. The device of claim 8, wherein the input unit includes a plurality of control keys.

12. The device of claim 8, wherein the control unit includes a control box, in which the setup unit, a timer and a control circuit having a universal code are installed therein, and the input unit is installed on a surface of the control box.
